(19) United States
(12) Patent Application Publication
(10) Pub. No.: US 2010/0125738 A1
(43) Pub. Date: May 20, 2010

(54) SYSTEMS AND METHODS FOR TRANSFERRING INFORMATION

(75) Inventors: Chu-Fei CHANG, Hsinchu (TW); Chun-Lung HUANG, Jhubei (TW); Shih-Chun WANG, Niaosong (TW)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: INDUSTRIAL TECHNOLOGY RESEARCH INSTITUTE, Chutung (TW)

(21) Appl. No.: 12/271,840

(22) Filed: Nov. 14, 2008

(51) Int. Cl. H04L 9/32

(52) U.S. Cl. 713/182

(57) ABSTRACT

A system for transferring information that includes a collection module configured to authenticate a user identifier if the user identifier is unique in the system, the user identifier being related to identity of the user, generate an encrypted object based on at least the user identifier and at least one webpage identifier in accordance with an algorithm, each of the at least one webpage identifiers being related to the identity of one of at least one webpages of the user, retrieve the encrypted object from one of the at least one webpages based on one of the at least one webpage identifiers, identify the integrity of the retrieved encrypted object, a management module configured to generate at least one information card based on the at least one webpage identifier in accordance with predetermined rules, a memory module configured to store at least one of the said user identifiers, the at least one webpage identifier and the at least one information card, and a dispatch module configured to dispatch the at least one information card.

### CROSS REFERENCE TO RELATED APPLICATION

This application is related to “Systems and Methods for Webpage Verification Using Data-Hiding Technology,” Ser. No. 12/165,520, filed on Jun. 30, 2008 by the inventors and commonly assigned to Industrial Technology Research Institute. This related application is incorporated herein by reference in its entirety.

### FIELD OF THE INVENTION

The present invention relates to information transfer and, more particularly, to systems and methods of transferring information across the Internet.

### BACKGROUND OF THE INVENTION

Communication technologies have created various online activities over the Internet, such as electronic transactions, online bidding, online swapping, communication within web communities, sharing information on web log (blog). Generally, each web service in which online activities are conducted may include a mechanism to rate an account or user. For example, the ratings system may convey the “reputation” of the account or user, such as trustworthiness, in an on-line transaction setting. The ratings are published such that users of the web service may easily learn the ratings of an account or user of interest. The effectiveness of such rating systems, however, may be limited by a number of factors. For example, a user may register many accounts in different web services. Ratings given to each account of this user may be different from one another, which may prevent other users from learning the true reputation of the user, or for identifying whether an identifier (ID) or account belongs to the user.

Technical schemes for transferring information between web services have been developed to facilitate information collection for a user. FIG. 1 is a flow diagram illustrating a conventional method of transferring ratings between more than one web services. Referring to FIG. 1, at step 101, the first web service may receive an e-mail address from the first user who may have successfully logged in the first system, where the e-mail address may be used to relate to a second web service. Next, the first web service may send a request to the received e-mail address at step 102, wherein the request may be a link or a uniform resource identifier (URI) related to an authentication webpage provided by the first web service. At step 103, the first web service may receive a response to the request, for example, the first user may respond to the request by connecting to the authentication webpage through the link or URI. After step 103, the first web service may inform the administrator or the staff dealing with at least a part of system administration to manually verify the ratings of the first user in the second web service at step 104, and the verified ratings may then be stored in the first system.

FIG. 2 is a flow diagram illustrating another conventional method of transferring ratings between more than one web services. Referring to FIG. 2, at step 201, a first web service may provide a first user with at least one authentication code. The first user may put the at least one authentication code on a first webpage in a second web service. The first web service may receive a link or URI related to the first webpage at step 202 and may further inform the administrator or the staff dealing with at least a part of system administration to manually identify whether the first webpage contain the at least one authentication code at step 203. If the first webpage contains the at least one authentication code, the administrator or staff may further verify the ratings in the second web service at step 204, and the verified ratings may then be stored in the first web service.

Obviously, the method as described and illustrated with reference to FIG. 1 may not be applied to the systems providing no e-mail service. Moreover, the authentication process shown in FIGS. 1 and 2 may be vulnerable to certain Internet crimes such as phishing and identity theft. Further, manual identification (step 203) and manual verification (step 104 or 204) are time-consuming and laborious. Some other methods have been developed to replace the aforesaid laborious work. One example is a website “www.rapleaf.com” (hereinafter referred to as “Rapleaf”) that enables a user to inspect and aggregate information from his/her social network account. Once a server dedicated to manage Rapleaf receives an e-mail address from a user, the server may automatically search for publicly available information about the user in accordance with the received e-mail address and in turn aggregate the information on Rapleaf. Although the manual verification is eliminated, Rapleaf system can only search for the information based on the e-mail address provided by the user. As such, Rapleaf cannot search for information from a web service without e-mail service. Moreover, Rapleaf guides users to leave new information, such as ratings, in its own reputation system but not in the systems from which the information is collected. Accordingly, many web services have developed mechanisms to block the icon of Rapleaf or text containing “rapleaf” to prevent its own rating system from being damaged by Rapleaf's system.

In addition, neither the method illustrated in FIG. 1 or 2 nor the systems like Rapleaf are able to provide or obtain real-time information. For example, in a method as described and illustrated with reference to FIG. 1, once the first user's information changes in the second or other web services, the first user may have to request the first web server to run steps 101 through 104 again for updating the information.

### BRIEF SUMMARY OF THE INVENTION

Examples of the present invention may provide a system for transferring information. The system comprises a collection module configured to authenticate a user identifier if the said user identifier is unique in the system, the said user identifier being related to the identity of the user, generate an encrypted object based on at least said user identifier and at least one webpage identifier in accordance with an algorithm, each of the webpage identifiers being related to the identity of one of webpages of the user, retrieve the encrypted object from one of the webpages based on one of the webpage identifiers, identify the integrity of the retrieved encrypted object; a management module configured to generate at least one information card based on the webpage identifiers in accordance with a predetermined rule; a memory module configured to store at least one of said user identifiers, the webpage identifiers and the information cards; and a dispatch module configured to dispatch the information cards.

Some examples of the present invention may also provide a system for transferring information. The system comprises a collection module configured to authenticate a user identifier if the user identifier is unique in the system, the user identifier being related to the identity of the user, generate an encrypted object based on at least said user identifier and at least one webpage identifier in accordance with an algorithm, each of the webpage identifiers being related to the identity of one of webpages of the user, retrieve the encrypted object from one of the webpages based on one of the webpage identifiers, identify the integrity of the retrieved encrypted object, retrieve a first information from the one of the webpages based on the one of the webpage identifiers; a management module configured to generate at least one information card based on the first information in accordance with a predetermined rule; a memory module configured to store at least one of the user identifiers, the webpage identifiers, the first information and the information cards; and a dispatch module configured to dispatch the information cards.

Other objects, advantages and novel features of the present invention will be drawn from the following detailed embodiments of the present invention with attached drawings, in which:

### BRIEF DESCRIPTION OF THE SEVERAL VIEWS OF THE DRAWINGS

The foregoing summary as well as the following detailed description of the preferred embodiments of the present invention will be better understood when read in conjunction with the appended drawings. For the purposes of illustrating the invention, there are shown in the drawings embodiments which are presently preferred. It is understood, however, that the invention is not limited to the precise arrangements and instrumentalities shown. In the drawings:

FIG. 1 is a flow diagram illustrating a conventional method for transferring ratings between more than one web service;

FIG. 2 is a flow diagram illustrating another conventional method for transferring ratings between more than one web service;

FIG. 3A is a schematic diagram illustrating a system for transferring information in accordance with one embodiment of the present invention;

FIG. 3B is a block diagram illustrating an exemplary operation of a service server of the system illustrated in FIG. 3A;

FIG. 4 is a schematic diagram illustrating personal information cards in accordance with an embodiment of the present invention;

FIG. 5 is a schematic diagram illustrating a system for transferring information in accordance with another embodiment of the present invention; and

FIGS. 6A-6C are flow diagrams illustrating exemplary methods for transferring ratings.

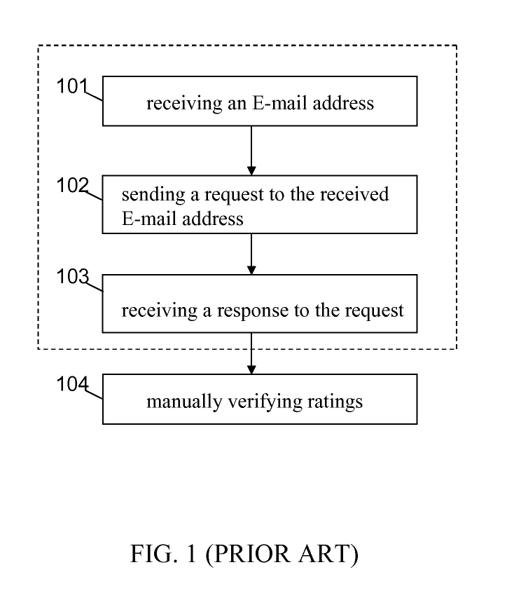

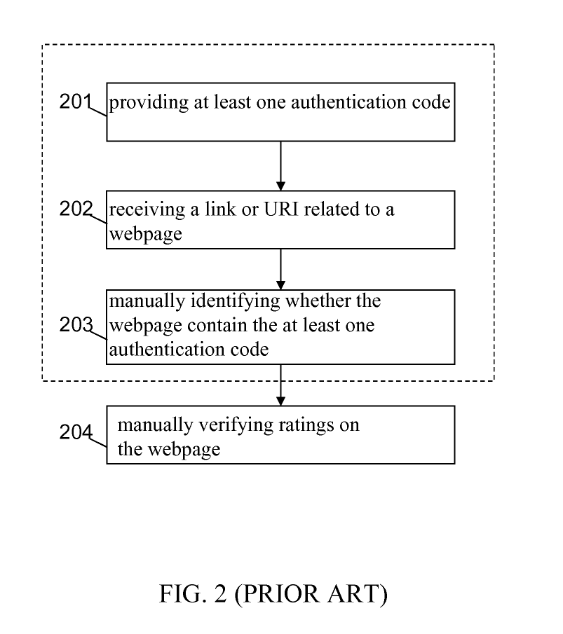

### DETAILED DESCRIPTION OF THE INVENTION

Reference will now be made in detail to the present examples of the invention illustrated in the accompanying drawings. Wherever possible, the same reference numbers will be used throughout the drawings to refer to the same or like portions.

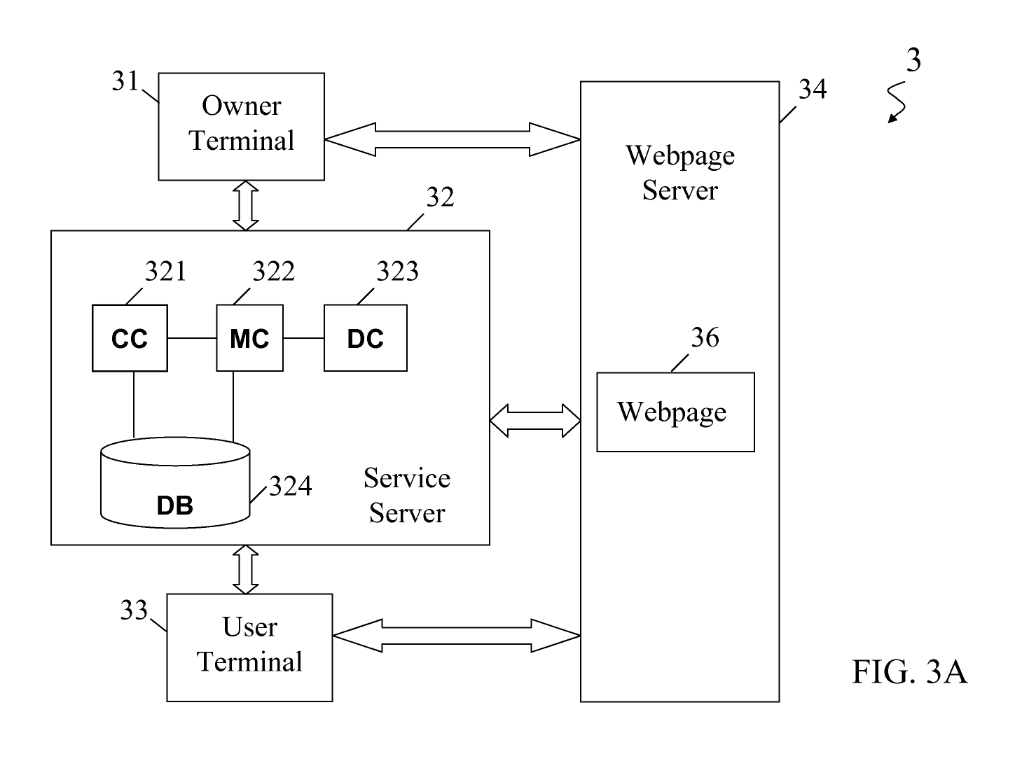

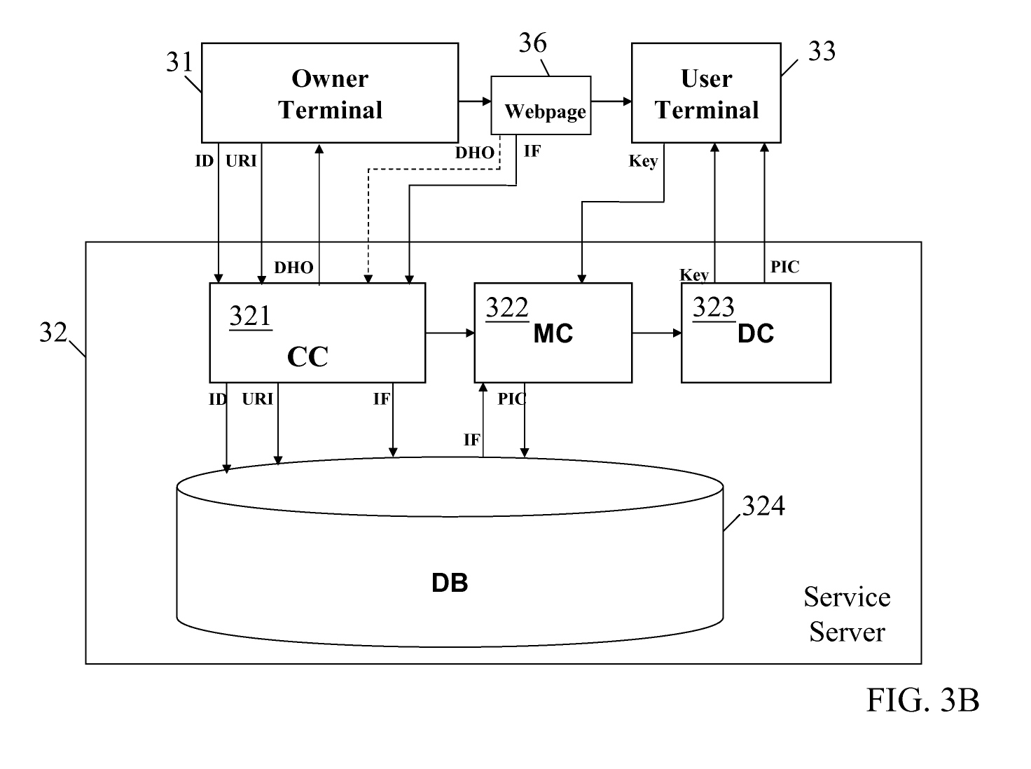

FIG. 3A is a schematic diagram illustrating a system 3 for transferring information in accordance with one embodiment of the present invention. Referring to FIG. 3A, the system 3 may include a service server 32, a webpage server 34, a user terminal 33 and an owner terminal 31. The service server 32 may be configured to support information transfer. The webpage server 34 may be configured to manage uplink or downlink of media contents such as image, text, audio, video and audio/video contents on a webpage 36. Each of the service servers 32 and the webpage servers 34 may include a computer, a workstation or a workstation computer. A user may access the service server 32 and the webpage server 34 through the user terminal 33, and an owner who may have the authority to administrate the webpage 36 established in the webpage server 34 may access the service server 32 and the webpage server 34 through the owner terminal 31. Each of the owner terminals 31 and the user terminals 33 may include one or more mobile phone, cell phone, personal digital assistant (PDA), personal computer (PC), mobile internet device (MID) or notebook computer, which may be configured to support communications over a network or the Internet.

The service server 32 may include a collection module or collection component (CC) 321, a management module or management component (MC) 322, a dispatch module or dispatch component (DC) 323 and a memory module or database (DB) 324. The service server 32 may be configured to facilitate the owner of the webpage 36 to claim his/her ownership and process the information retrieved from the webpage 36 in accordance with a predetermined rule. The components CC 321, MC 322 and DC 323 may be implemented in hardware or software, in which the former may be more advantageous in view of operation speed while the latter may be more cost effective in view of design complexity. If implemented in hardware, these components 321-323 may include modules mounted in the service server 32. If implemented in software, these components 321-323 may include executable programs or applications installed on the service server 32. Operation of the system 3 will be discussed by reference to FIG. 3B below.

FIG. 3B is a block diagram illustrating exemplary operation of the service server 32 of the system 3 illustrated in FIG. 3A. Referring to FIG. 3B, CC 321 may be configured to receive a user identifier “ID” from a first user, such as the owner, via a first terminal, i.e., the owner terminal 31 and identify whether the user identifier is distinguishable from other user identifiers already registered with CC 321 and stored in DB 324 of the system 3. The user identifier related to the identity of the first user may be stored in DB 324 when authenticated. In one example, the user identifier may include, but is not limited to, an account number, with which the first user may login to the service server 32, an e-mail address, a mobile phone number or an OpenID identifier. An OpenID may refer to an identity service, which allows a user to log on different websites or webpages using a single digital identity. The CC 321 may reject a user identifier if such user identifier has been used by another user in the system 3 and may request the owner to provide another unique user identifier in order to distinguish himself/herself from the other users in the system 3. The CC 321 may be configured to receive one or more webpage identifiers “URI” from the first user. Each of the webpage identifiers may be related to the identity of a webpage of the first user, for example, a universal resource identifier (URI) or universal resource locator (URL) of the webpage. In one example, the user identifier may include an e-mail address of the first user, for example, victor@yahoo.com, and one of the webpage identifiers may include the URI of the webpage of the first user, for example, http://myblog.example.com/victor. The webpage identifiers may then be stored in the database 324.

Based on the user identifier and the webpage identifiers, CC 321 generates a signature S in accordance with a first data-hiding algorithm and embeds the signature S into a base object such as digital content including image, audio or video in accordance with a second data-hiding algorithm. In one embodiment, the first data-hiding algorithm includes a “sha1” algorithm and the second data-hiding algorithm includes, but is not limited to, a watermark algorithm. In other embodiments CC 321 embeds the user identifier and the webpage identifiers into a base object based on the second data-hiding algorithm. The base object may be provided by the first user (not shown) or the service server 32. A data-hidden object DHO generated by CC 321, for example a “watermarked” object, is then sent to the first user and stored in DB 324. Furthermore, the second data-hiding algorithm and, if available, the first data-hiding algorithm together with their relevant parameters may be stored in DB 324 to facilitate extraction of the user identifier from the signature S. The first user subsequently places the DHO on his/her webpage.

The CC 321 may also be configured to, upon request by the first user, confirm the ownership of one of the webpages including webpage 36. To confirm that the first user is the owner of the webpage 36, CC 321 retrieves a first DHO (shown by a dotted line) from webpage 36 and checks the integrity of the first DHO. Examples for checking the integrity of the first DHO are described in U.S. patent application Ser. No. 12/165,520, which has been incorporated herein by reference in its entirety. After the ownership of the webpage is confirmed, the CC 321 accesses the webpage to retrieve information IF, including the ratings or an image showing the ratings. In another example, the CC 321 parses the webpage to extract IF which includes text indicating the ratings. The webpage identifiers and the IF are then stored in DB 324.

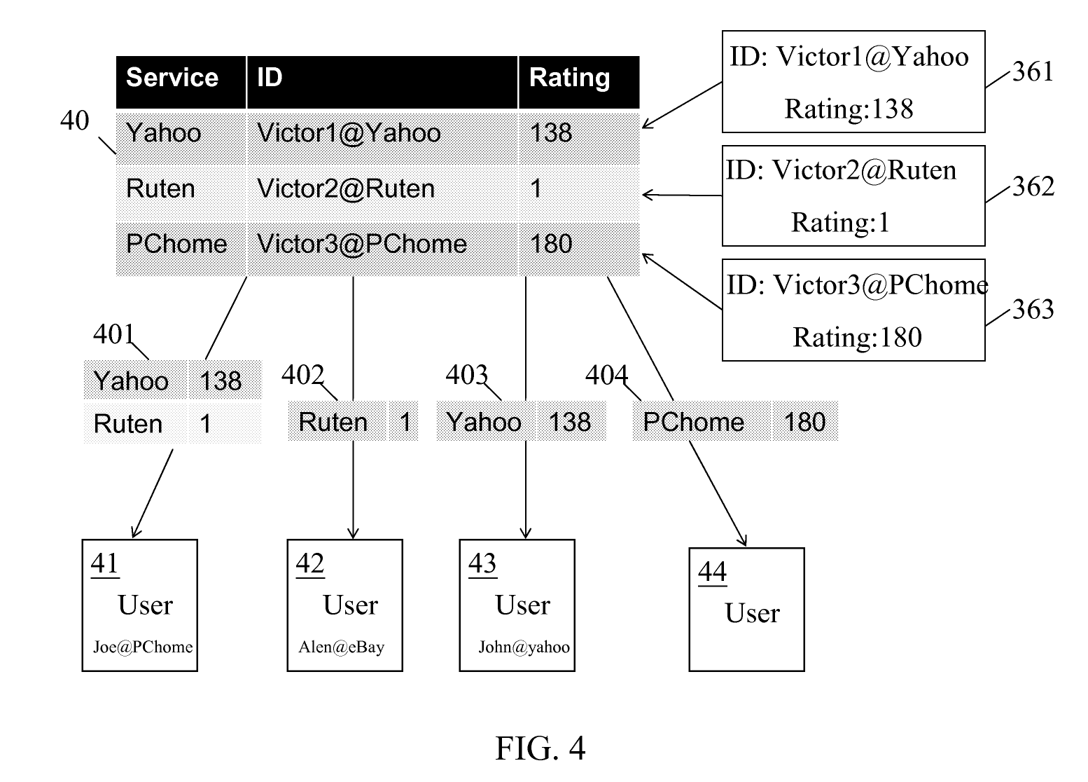

The MC 322 is configured to receive the webpage identifiers and the IF from the CC 321 or retrieve the same from the DB 324. The MC 322 is configured to generate at least one personal information card (PIC) in accordance with the predetermined rule, which is then stored in DB 324. In one embodiment, the PIC includes at least one of the ratings or the image showing the ratings retrieved from the webpages of the owner. In another embodiment of the present invention, the PIC includes the webpage identifiers. The predetermined rule may include one or more of the following parameters: whether a user is authorized to receive the PIC, whose rating(s) or webpage(s) showing the ratings are going to be revealed to an authorized user, a time limit or a number of times for accessing the PIC, a valid time of the PIC. FIG. 4 illustrates personal information cards (PICs) in accordance with an embodiment of the present invention and is described in details below.

The DC 323 is configured to receive from the MC 322 one or more notice regarding generation of a personal information card, PIC, and to dispatch the personal information card to one or more user. In another embodiment, after receiving the notices from the MC 322, the DC 323 notifies a user that he can now retrieve his/her PIC. For example, the DC 323 may notify the user and provide him with a key to retrieve his/her personal information card. In yet another embodiment, the key provided by the DC 323 may have a valid time, which means that if the user does not use the key to retrieve his/her PIC within the predetermined time period, the key will longer be valid.

FIG. 4 is a schematic diagram illustrating personal information cards in accordance with one of the embodiments of the present invention. Referring to FIG. 4, in one of the embodiments at least one information sheet 40 is stored in the DB 324 as described and illustrated with reference to FIGS. 3A and 3B. As an example, the first column of the information sheet 40 may include different service providers such as “Yahoo,” “Ruten” or “PChome.” Each provider may provide to the owner “Victor” a user identifier ID as shown in the second column. This ID can be used for administrating his/her own webpage. The third column of the information sheet 40 may include the ratings 361, 362 and 363 retrieved or extracted from different webpages which have been verified to be owned by the same owner who may register different user identifier ID, “Victor 1,” “Victor 2” and “Victor3” with different service providers. Based on the information sheet 40, personal information cards PIC 401, 402, 403 and 404 can be generated in accordance with predetermined rules. For example, if the owner “Victor” wants to show the ratings of his/her own webpage in “Yahoo” and “Ruten” to user 41, the owner may request that the MC 322 generates PIC 401 through the terminal 31 as described and illustrated on FIG. 3B. Similarly, personal information cards 402, 403 and 404 may be sent to the users 42, 43 and 44 respectively, where these users are registered with different service providers. In another example, each PIC has such webpage identifiers that the user who receives his/her PIC learns the ratings by linking back to a webpage of the service provider with the webpage identifier. In yet another example, each PIC contains at least one image, where the image includes the rating of “Victor.”

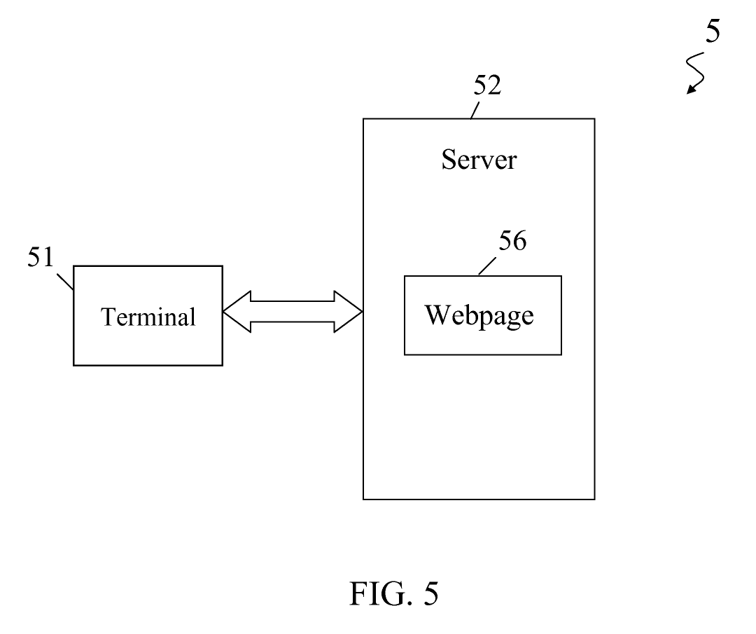

FIG. 5 is a schematic diagram illustrating system 5 for transferring information in accordance with another embodiment of the present invention. Referring to FIG. 5, the system 5 includes a server 52, a webpage 56 and a terminal 51. In one of the embodiments the server 52 is configured to support the functions of the service server 32 and the webpage server 34 described and illustrated with reference to FIG. 3A. The terminal 51 is configured to facilitate access to the webpage 56 by the owner of the webpage 56 and the user of the system 5.

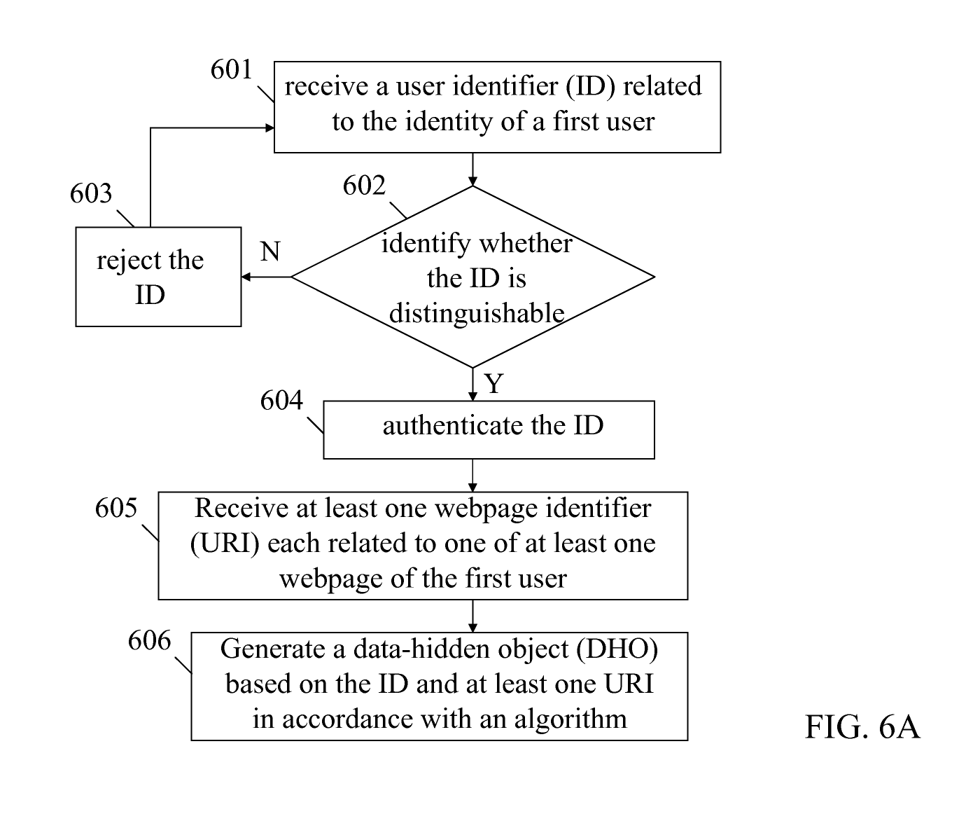

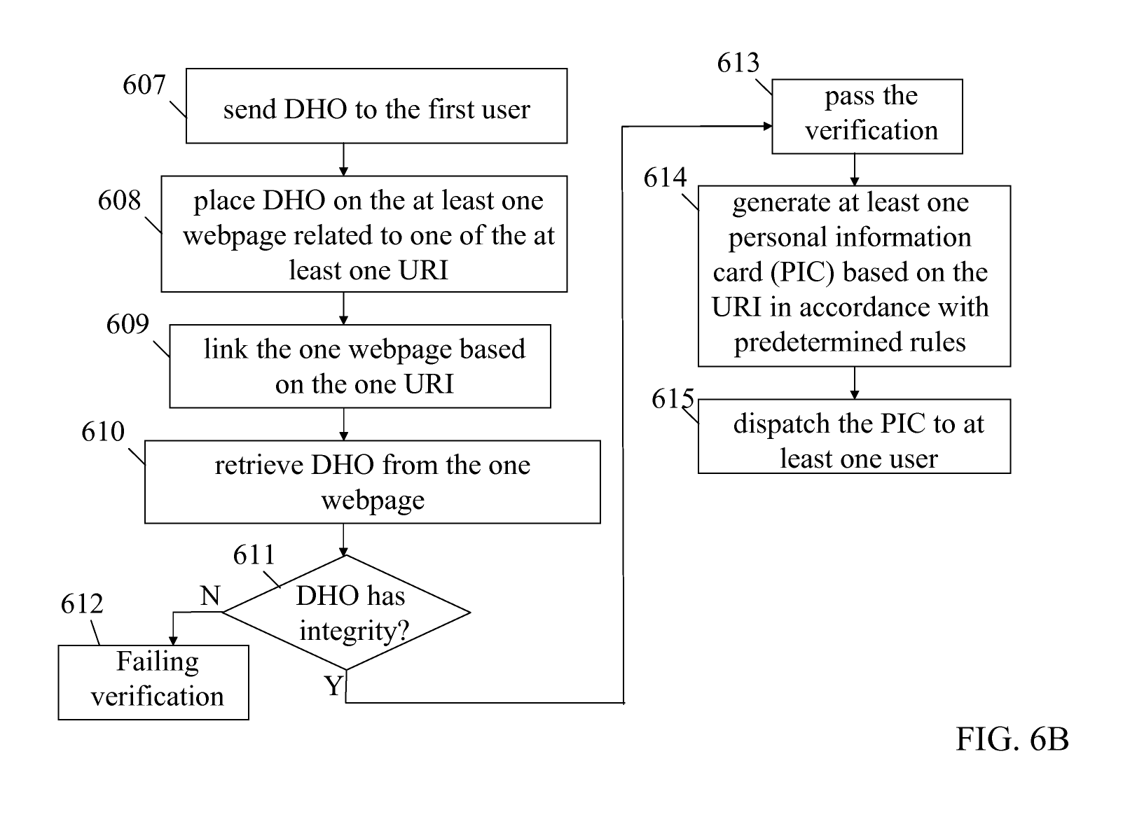

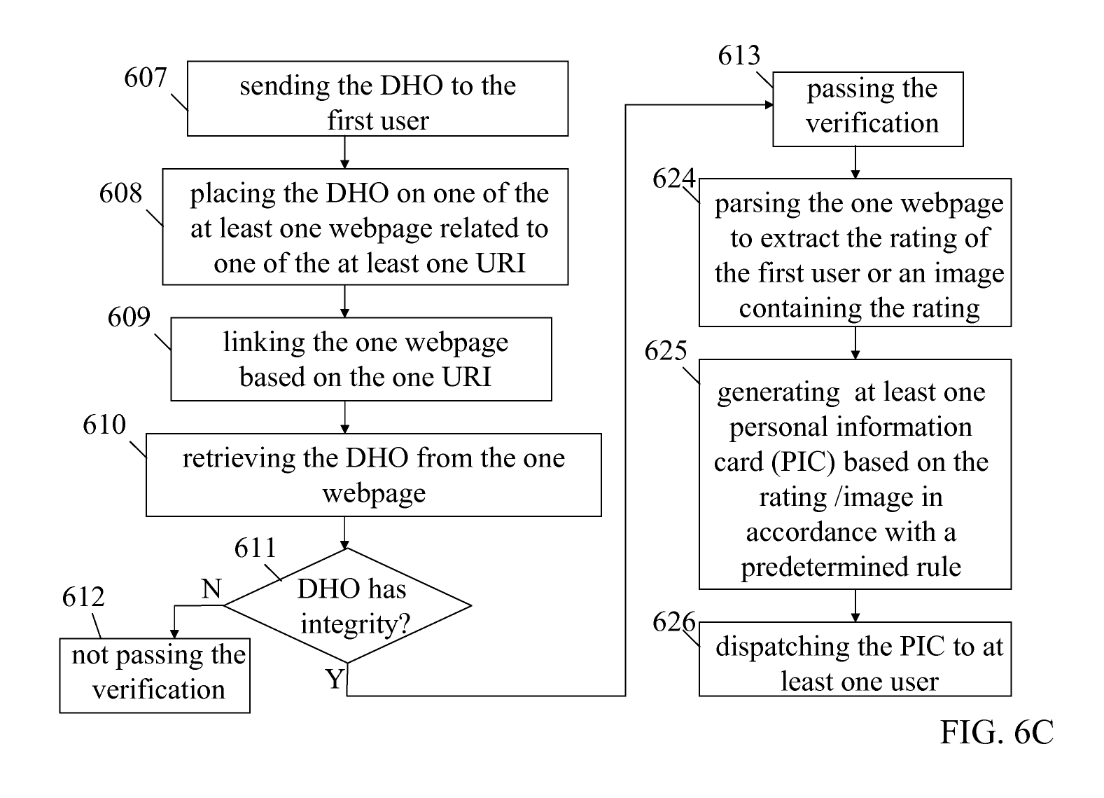

FIGS. 6A-6C are flow diagrams illustrating exemplary methods of transferring ratings. Referring to FIG. 6A, at step 601, a user identifier (ID) related to the identity of a first user is received by a server. The server includes the service server 32 described and illustrated with reference to FIGS. 3A and 3B, respectively. At step 602, the system identifies whether the ID is distinguishable from the other user identifiers (IDs), which have been registered with the server. If not, at step 603 the ID is rejected. The server subsequently requests a new ID from the first user. If the ID is not a duplicate, at step 604 the ID is authenticated and then stored on the server.

Next, at step 605 at least one webpage identifier (denoted as URI) from the first user is received by the server. Each of the URIs is related to a universal resource identifier or universal resource locator for one of the webpages of the first user. At step 606, a data-hidden object (DHO) is generated by the server based on the ID and the URI in accordance with a data-hiding algorithm, for example, the watermark algorithm. In one example, the ID and the URI are formed into a signature, which in turn is embedded into a base object. In another embodiment, the ID and the URI are directly embedded into a base object at step 606, using the data-hiding algorithm without forming a signature.

Referring to FIG. 6B, in one of the embodiments at step 607 the DHO is sent from the server to the first user. At step 608 the first user places the DHO on one or more of the webpages related to the URIs. For simplicity, it is assumed that the first user places the first DHO on one of the webpages with one of the URIs even though in reality the first user may place the DHO on more than one of his or her webpages. The first user claims his/her ownership of the webpage through the following steps. At step 609, based on the one URI, which may be provided by the first user during the ownership claim process, the one webpage with the one URI is linked. The DHO is retrieved from the one webpage at step 610. At step 611, the integrity of the retrieved DHO is checked. If the integrity of the DHO is damaged, at step 612 it will be determined that the webpage does not pass verification. If the DHO's integrity is intact, at step 613 it is identified that the webpage passes verification. Next, at step 614 at least one personal information card PIC is generated based on the one URI in accordance with the predetermined rule. Then at step 615 the PIC is dispatched to at least one user.

Referring to FIG. 6C, in another embodiment after step 613 the one webpage is parsed at step 624 to extract the rating of the first user or an image containing the rating. Then at step 625, the personal information card PIC is generated based on the rating and/or image extracted at step 624 in accordance with the predetermined rules. At step 626 the PIC is then dispatched to at least one user.

In describing representative embodiments of the present invention, the specification may have presented the method and/or process of operating the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

It will be appreciated by those skilled in the art that changes could be made to the examples described above without departing from the broad inventive concept thereof. It is understood, therefore, that this invention is not limited to the particular examples disclosed, but it is intended to cover modifications within the spirit and scope of the present invention as defined by the appended claims.

We claim:

1. A system for transferring information, comprising:
a collection module configured to
authenticate a user identifier if the user identifier is unique in the system,
generate an encrypted object based on at least the user identifier and at least one webpage identifier in accordance with an algorithm, each of the at least one webpage identifiers being related to the identity of one of the at least one webpage of the user,
retrieve the encrypted object from one of the at least one webpages based on one of the at least one webpage identifiers, and
identify the integrity of the retrieved encrypted object;
a management module configured to generate at least one information card based on the at least one webpage identifier in accordance with a predetermined rule;
a memory module configured to store at least one of the user identifiers, the at least one webpage identifier and the at least one information card; and
a dispatch module configured to dispatch the at least one information card.

2. The system of claim 1, wherein the predetermined rule determines whether at least one of the other users is authorized to receive one of the at least one information cards.

3. The system of claim 2, wherein the predetermined rule selects the at least one webpage identifier for each of the at least one information cards.

4. The system of claim 3, wherein the predetermined rule comprises determining a valid time for at least one of the information cards.

5. The system of claim 3, wherein the predetermined rule determines the number of times for accessing at least one of the information cards.

6. The system of claim 3, wherein the predetermined rule determines a time limit for accessing at least one of the information cards.

7. The system of claim 1, wherein the dispatch module is configured to provide a key to at least one of the other users to facilitate the dispatch of the at least one information card.

8. The system of claim 7, wherein the key has a valid time.

9. A system for transferring information, comprising:
a collection module configured to
authenticate a user identifier if the user identifier is unique in the system, the said user identifier being related to the identity of a user,
generate an encrypted object based on at least the user identifier and at least one webpage identifier in accordance with an algorithm, each of the at least one webpage identifiers being related to the identity of one of at least one webpages of the user,
retrieve the encrypted object from one of the at least one webpages based on one of the at least one webpage identifiers,
identify the integrity of the retrieved encrypted object,
retrieve a first information from the one of the at least one webpages based on the one of the at least one webpage identifiers;
a management module configured to generate at least one information card based on the first information in accordance with a predetermined rule;
a memory module configured to store at least one of the said user identifiers, the at least one webpage identifier and the at least one information card; and
a dispatch module configured to dispatch the at least one information card.

10. The system of claim 9, wherein the predetermined rule determines whether at least one of the other users is authorized to receive one of the at least one information cards.

11. The system of claim 10, wherein the predetermined rule selects the first information for at least one of the information cards.

12. The system of claim 11, wherein the predetermined rule determines a valid time for at least one of the information cards.

13. The system of claim 11, wherein the predetermined rule determines the number of times for accessing at least one of the information cards.

14. The system of claim 11, wherein the predetermined rule determines a time limit for accessing at least one of the information cards.

15. The system of claim 9, wherein the dispatch module is configured to provide a key to at least one of the other users to facilitate the dispatch of the at least one information card.

16. The system of claim 15, wherein the key has a valid time.

17. The system of claim 9, wherein the collection module is configured to parse the one of at least one webpages of the user to retrieve the first information

18. The system of claim 17, wherein the first information comprises text information.
